(19) United States
(12) Patent Application Publication
(10) Pub. No.: US 2023/0267365 A1
(43) Pub. Date: Aug. 24, 2023

(54) GENERATING TRAINING CURRICULA FOR A PLURALITY OF REINFORCEMENT LEARNING CONTROL AGENTS

(71) Applicant: International Business Machines Corporation, Armonk, NY (US)

(72) Inventors: Lan Ngoc HOANG, Timperley (GB); Alexander ZADOROJNIY, Haifa (IL); Akifumi WACHI, Machida (JP)

(21) Appl. No.: 17/678,072

(22) Filed: Feb. 23, 2022

(51) Int. Cl. G06N 20/00

(52) U.S. Cl. CPC G06N 20/00

(57) ABSTRACT

Computer hardware and/or software for generating training curricula for a plurality of reinforcement learning control agents, the hardware and/or software performing the following operations: (i) obtaining system data describing at least one operating parameter of a system based, at least in part, on at least one of a plurality of reinforcement learning control agents failing to satisfy a control criterion for the system; (ii) generating a set of training curricula based, at least in part, on at least one operating parameter of the system and at least one training policy for the plurality of reinforcement learning control agents; and (iii) communicating the set of training curricula to the plurality of reinforcement learning control agents.

### BACKGROUND

The present invention relates generally to the field of machine learning, and more particularly to reinforcement-type machine learning, or “Reinforcement Learning.”

Reinforcement Learning is an approach using an iterative process of learning via rewards to adapt to an environment. Reinforcement Learning (RL) control agents rely on simulated benchmark tasks and environments for training and acquiring a target skill/policy. A popular approach uses a mechanism termed curriculum learning, in which the agent is trained via various settings or environments representing different difficulties and levels.

### SUMMARY

According to an aspect of the present invention, there is a method, computer program product, and/or system that performs the following operations (not necessarily in the following order): (i) obtaining system data describing at least one operating parameter of a system based, at least in part, on at least one of a plurality of reinforcement learning control agents failing to satisfy a control criterion for the system; (ii) generating a set of training curricula based, at least in part, on at least one operating parameter of the system and at least one training policy for the plurality of reinforcement learning control agents; and (iii) communicating the set of training curricula to the plurality of reinforcement learning control agents.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 is a block diagram of an example system in which aspects of the illustrative embodiments may be implemented;

FIG. 2 is a flow diagram of a method for training a plurality of reinforcement learning control agents configured to control a system according to an exemplary embodiment;

FIG. 3 is a flow diagram of a computer-implemented method for reinforcement learning control of a system according to an aspect of an exemplary embodiment;

FIG. 4 is a simplified block diagram illustrating the use of a set control agents for controlling various components of a wastewater treatment system according to a proposed concept; and

FIG. 5 is a simplified block diagram of a computer system on which a method according to a proposed embodiment may be executed.

### DETAILED DESCRIPTION

Various embodiments of the present invention provide a computer-implemented method for training a plurality of reinforcement learning control agents configured to control a system.

Various embodiments of the present invention further provide a computer program comprising computer program code means which is adapted, when said computer program is run on a computer, to implement a method for training a plurality of reinforcement learning control agents configured to control a system.

Various embodiments of the present invention additionally provide a system for training a plurality of reinforcement learning control agents configured to control a system.

According to an aspect of the present invention, there is provided a computer-implemented method for training a plurality of reinforcement learning control agents configured to control a system. The method comprises, responsive to at least one of the plurality of reinforcement learning control agents failing to satisfy a control criterion for the system, obtaining system data describing at least one operating parameter of the system. The method also comprises generating a set of training curricula (also referred to as “curriculums”) based on the at least one operating parameter of the system and at least one training policy for the plurality of reinforcement learning control agents. The method yet further comprises communicating the set of training curricula to the plurality of reinforcement learning control agents.

According to a further aspect of the invention, there is provided a computer program comprising computer program code means which is adapted, when said computer program is run on a computer, to implement a method for training a plurality of reinforcement learning control agents configured to control a system.

According to an aspect of the invention, there is provided a system for training a plurality of reinforcement learning control agents configured to control a system. The system comprises an interface component configured to obtain, responsive to at least one of the plurality of reinforcement learning control agents failing to satisfy a control criterion for the system, system data describing at least one operating parameter of the system. The system also comprises a processor component configured to generate a set of training curricula based on the at least one operating parameter of the system and at least one training policy for the plurality of reinforcement learning control agents. The system yet further comprises a communication component configured to communicate the set of training curricula to the plurality of reinforcement learning control agents.

Concepts are proposed for a linked curriculum system to provide joint curricula for multiple control agents, and this may be done based on a real time (or near real-time) context. For instance, embodiments may provide a mechanism for linked individual curriculum training in a group setting that adapts to real-time situation data. Accordingly, embodiments may provide many benefits or advantages, such as: reward shaping and abstraction of environment for target tasks; contextual-based curriculum for individual control agents in a multi-agent setting; and/or co-curriculum for multi-agents.

These and other aspects of the invention will be apparent from and elucidated with reference to the embodiment(s) described hereinafter. Various embodiments of the present invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

Variations to the disclosed embodiments can be understood and effected by those skilled in the art in practicing the claimed invention, from a study of the drawings, the disclosure and the appended claims. In the claims, the word “comprising” does not exclude other elements or operations, and the indefinite article “a” or “an” does not exclude a plurality. If the term “adapted to” is used in the claims or description, it is noted the term “adapted to” is intended to be equivalent to the term “configured to”.

In the context of the present application, where embodiments of the present invention constitute a method, it should be understood that such a method may be a process for execution by a computer, i.e., may be a computer-implementable method. The various operations of the method may therefore reflect various parts of a computer program, e.g., various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

The complexity of controlling some systems can makes it a difficult for a fixed, pre-trained control agent to perform adequate control. An approach in Reinforcement Learning (RL) known as curriculum learning is therefore desirable, in which a control agent is trained via a sequence of training settings (or levels) to acquire the target skills, instead of being required to attain the skills from one single training setup.

However, standard RL approaches only address the curriculum of a single agent and disregard how updating an agent policy might create changes in the overall environment (i.e., one control agent may reach a locally optimal state, but at the expense of disrupting other system components). For example, in real life applications, a target task can change dynamically to situations and there might be a need for acquiring a skill in a timely manner and based on the actual situation rather than a pre-planned curriculum. As a result, training must be repeated across all the individual control agents and take into account the simultaneous updates from other agents (due to them undergoing their own curriculum training). Conventional curriculum approaches all target a single control agent setting.

Implementations in accordance with the present disclosure relate to various techniques, methods, schemes and/or solutions pertaining to reinforcement learning control agents configured to control a system. In particular, it is proposed to generate a set of training curricula based on an operating parameter of the system and one or more training polices for the control agents. The generated set of training curricula can then be provided (e.g., transmitted) to the plurality of control agents. In this way, there may be provided an approach that combines actions and training of multiple agents to a common joint curriculum.

Put another way, embodiments may propose linking the curriculum of multiple RL-based control agents (otherwise referred to as “RL agents”) agents together in a distributed fashion, ensuring common, overall goals can be satisfied. This may provide improvements over existing approached, such as: reduced iteration update cycles for control agent training (reducing wear and tear on mechanical system components, for example); and/or reduced communication overhead.

One or more proposed concepts may therefore provide for performing linked, distributed training of multiple (student) control agents in reinforcement learning systems. Purely by way of summary and example, this may include the following main stages:
(i) A pre-trained control agent attached to a system component (e.g., an autonomous vehicle) is deployed into the operating environment and continuously collects data relating to its performance to develop a reward signal;
(ii) The control agent employs an RL approach to iteratively construct a simulated environment reflecting the operating conditions and monitors the performance in the environment along with the real conditions; and
(iii) When simulations show that the control agent fails to satisfy performance and safety criteria, a curriculum for training the agent is constructed based on the simulation as the benchmark task/environment. A subset of environments is also constructed for incremental training until the safety conditions are satisfied.

Thus, in such a setting, each of a plurality of control agents continuously monitors the environment. Using data gathered, agent policies and the environment simulator are updated. When the simulator indicates an unsafe operation, the corresponding agent triggers the generation of a new curriculum, which also triggers the updating of other agents’ curriculum. A central curriculum generator can be employed to provide a set of curriculum environments to each individual control agents, either via centralized simulation of agent evolutions based on all data feeds, or via individual curriculum sending (with agents periodically pinging others with their current curriculum).

Embodiments may be thought of as employing a teacher component and a plurality of student components. The teacher component may, for example, be a ‘macro’ agent which is configured to send curriculums to the plurality of control agents. The student components may then be the plurality of control agents attached to the control system.

The proposed concept(s) may therefore have applicability to many different reinforcement learning settings and applications, including industrial applications, sensor control, and supply chain / multi-agent optimization problems for example.

In some embodiments, generating the set of training curricula may comprise: translating system data into a first set of Markov Decision Processes (MDPs); translating at least one training policy into a second set of MDPs; and determining the set of training curricula based on the first and second sets of MDPs. In this way, embodiments may use system observations to generate a combined set of MDPs for all control agents and then use a mixture network to decompose the set into a linked curriculum based on predicted policies of each control agent.

For example, determining the set of training curricula based on the first and second sets of MDPs may comprise: combining MDPs of the first and second set into vectors; generating a graph of MDPs based on the vectors; and linking MDPs based on the generated graph.

In some embodiments, determining the set of training curricula based on the first and second sets of MDPs may comprise: factoring one or more of the MDPs of the first and second set into adjusted and rearranged sequence of MDPs for a first control agent of the plurality of reinforcement learning control agents; and generating, based on the adjusted and rearranged sequence of MDPs, a training curriculum for the first control agent.

Unlike conventional approaches that generate tasks for a single agent (such as providing a training curriculum for the agent from MDP_1 to MDP_2), embodiments of the proposed curriculum generation concept may instead provide a linked set of MDPs from 1 to 2 to train a plurality of agents. The aggregation of actual policies of the first set of MDPs may represent the target environment, and the second set may represent a continually updating (e.g., evolving) sequence of MDPs for all the agents to learn.

The control criterion may comprise at least one of: (i) a reward signal representing the agent performance with regard to the training MDPs and predicted performance in the target MDP; or (ii) criterion important for agent operation, such as safety and risks, uncertainty threshold, etc. For example, in various embodiments, the control criterion is selected from the group consisting of: (i) a reward signal representing agent performance; (ii) a predicted performance; (iii) a safety requirement; and (iv) an uncertainty threshold.

Turning to other embodiments, the operation of generating a set of training curricula may be undertaken by at least one of the plurality of reinforcement learning control agents. That is, one of the plurality of the control agents may be the ‘teacher’, thus avoiding the need for a separate, centralized teacher component.

In other exemplary embodiments, however, the operation of generating a set of training curricula may be undertaken by a teacher agent adapted to receive system data from the plurality of reinforcement learning control agents. Some embodiments may thus employ a central macro agent as a teacher component, thereby alleviating resource and/or processing requirements from the plurality of control agents.

The proposed training concept(s) may be employed in a variety of control applications/systems, so as to provide improved reinforcement learning control of a system. That is, proposals may provide a method/system for reinforcement learning control of a system, wherein the method/system comprises training a plurality of reinforcement learning control agents according to a proposed embodiment.

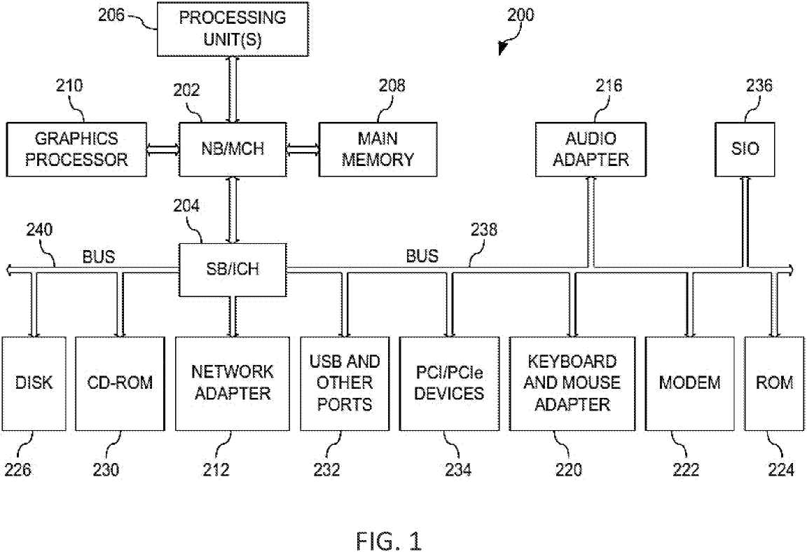

Turning now to FIG. 1, there is presented a block diagram of an example system 200 in which aspects of the illustrative embodiments may be implemented. The system 200 is an example of a computer, such as client in a distributed processing system, in which computer usable code or instructions implementing the processes for illustrative embodiments of the present invention may be located. For instance, the system 200 may be configured to implement a processor component and a communication component according to an embodiment.

In the depicted example, the system 200 employs a hub architecture including a north bridge and memory controller hub (NB/MCH) 202 and a south bridge and input/output (I/O) controller hub (SB/ICH) 204. A processing unit 206, a main memory 208, and a graphics processor 210 are connected to NB/MCH 202. The graphics processor 210 may be connected to the NB/MCH 202 through an accelerated graphics port (AGP).

In the depicted example, a local area network (LAN) adapter 212 connects to SB/ICH 204. An audio adapter 216, a keyboard and a mouse adapter 220, a modem 222, a read only memory (ROM) 224, a hard disk drive (HDD) 226, a CD-ROM drive 230, universal serial bus (USB) ports and other communication ports 232, and PCI/PCIe devices 234 connect to the SB/ICH 204 through first bus 238 and second bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

The HDD 226 and CD-ROM drive 230 connect to the SB/ICH 204 through second bus 240. The HDD 226 and CD-ROM drive 230 may use, for example, an integrated drive electronics (IDE) or a serial advanced technology attachment (SATA) interface. Super I/O (SIO) device 236 may be connected to SB/ICH 204.

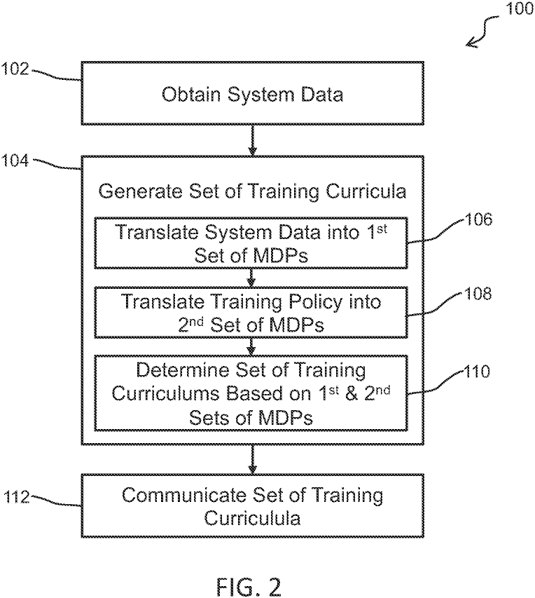

An operating system runs on the processing unit 206. The operating system coordinates and provides control of various components within the system 200 in FIG. 2. As a client, the operating system may be a commercially available operating system. An object-oriented programming system, such as the JAVA programming system, may run in conjunction with the operating system and provides calls to the operating system from JAVA programs or applications executing on system 200. (Note: the term “JAVA” may be subject to trademark rights in various jurisdictions throughout the world and is used here only in reference to the products or services properly denominated by the mark to the extent that such trademark rights may exist.)

As a server, system 200 may be, for example, an IBM POWER computer system, running the Advanced Interactive Executive (AIX) operating system or the LINUX operating system. The system 200 may be a symmetric multiprocessor (SMP) system including a plurality of processors in processing unit 206. Alternatively, a single processor system may be employed. (Note: the term(s) “IBM,” “POWER,” “AIX,” and/or “LINUX” may be subject to trademark rights in various jurisdictions throughout the world and are used here only in reference to the products or services properly denominated by the marks to the extent that such trademark rights may exist.)

Instructions for the operating system, the programming system, and applications or programs are located on storage devices, such as HDD 226, and may be loaded into main memory 208 for execution by processing unit 206. Similarly, one or more message processing programs according to an embodiment may be adapted to be stored by the storage devices and/or the main memory 208.

The processes for illustrative embodiments of the present invention may be performed by processing unit 206 using computer usable program code, which may be located in a memory such as, for example, main memory 208, ROM 224, or in one or more peripheral devices 226 and 230.

A bus system, such as first bus 238 or second bus 240 as shown in FIG. 2, may comprise one or more buses. Of course, the bus system may be implemented using any type of communication fabric or architecture that provides for a transfer of data between different components or devices attached to the fabric or architecture. A communication unit, such as the modem 222 or the network adapter 212 of FIG. 1, may include one or more devices used to transmit and receive data. A memory may be, for example, main memory 208, ROM 224, or a cache such as found in NB/MCH 202 in FIG. 1.

Those of ordinary skill in the art will appreciate that the hardware in FIG. 1 may vary depending on the implementation. Other internal hardware or peripheral devices, such as flash memory, equivalent non-volatile memory, or optical disk drives and the like, may be used in addition to or in place of the hardware depicted in FIG. 1. Also, the processes of the illustrative embodiments may be applied to a multiprocessor data processing system, other than the system mentioned previously, without departing from the spirit and scope of the present invention.

Moreover, the system 200 may take the form of any of a number of different data processing systems including client computing devices, server computing devices, a tablet computer, laptop computer, telephone or other communication device, a personal digital assistant (PDA), or the like. In some illustrative examples, the system 200 may be a portable computing device that is configured with flash memory to provide non-volatile memory for storing operating system files and/or user-generated data, for example. Thus, the system 200 may essentially be any known or later-developed data processing system without architectural limitation.

Referring now to FIG. 2, there is presented a flow diagram 100 of a method for training a plurality of reinforcement learning control agents configured to control a system. Here, the set of control agents are for controlling various components of a wastewater treatment system and are adapted to communicate information about their performance and training program via a communication network (e.g., wireless mesh network and/or the Internet).

Also, in this example, the system comprises a macro agent - a teacher agent that is in charge of the training design and the overall performance and cost of the plurality of reinforcement learning control agents (i.e., the ‘students’). The students therefore control parameters of wastewater treatment system, such as aeration rates in each aerated tanks and the internal recycling rate for example.

High set points or a RL policy to maximize the aeration rate in each individual tank will increase the efficiency of treatment, but this incurs high energy cost and, in the case of a controller in each tank adopting a policy of high treatment set point, it can become excessive. However, it is not possible to predetermine the policies, as the treatment needs to adapt to the volume and the load coming into the system. A curriculum will help accelerate the policy changes needed to adapt to the dynamic system, such as those concerning uncertainty and risk tolerance in the policies.

A curriculum for such an embodiment includes three components:
(a) A component to translate the system data into Markov Decision Processes (MDPs) of states, actions, and rewards;
(b) A component to translate the source task into a set/mixture of MDPs into tasks and sequences for training; and
(c) A simulator to implement the MDPs into a training ground for student agents to be trained on and to provide performance/improvement signals back to the teacher agent.

The exemplary method of FIG. 2 addresses the issue of isolated curriculum training for a complex, interdependent system such as in the exemplary wastewater treatment plant.

In operation 102, responsive to at least one of the plurality of reinforcement learning control agents failing to satisfy a control criterion for the system, the macro agent obtains system data describing at least one operating parameter of the system.

Next, in operation 104, the macro agent generates a set of training curricula based on the at least one operating parameter of the system and at least one training policy for the plurality of reinforcement learning control agents. That is, the macro (i.e., ‘teacher’) agent is adapted to receive system data from the plurality of reinforcement learning control agents and is further adapted to undertake the operation 104 of generating a set of training curricula.

Examples may include a safety parameter of the system, such as safety metrics on collision, system overload, etc. For this example of a wastewater treatment plant, these metrics may comprise the concentration of pollutants being released at the plant output. The teacher agent extracts these metrics from the monitoring data or from agent observations. The teacher agent then computes the distance of these metrics from a target performance metric, matches the metrics to a subtask or a subgoal (or multiple subtasks and subgoals) and generates the MDPs (e.g., using the task or plan decompositional techniques or task creation for curriculum learning in known approaches).

In this example, operation 104 of training curriculas comprises three sub-operations 106, 108 & 110:
Operation 106 comprises translating system data into a first set of Markov Decision Processes, MDP using performance metrics (e.g., example metrics detailed above), predefined state and action spaces and using known/existing techniques for MDP framework generation from the data;
Operation 108 comprises translating the at least one training policy into a second set of MDPs using one or multitude of mixture networks to factorize the MDPs and adjust the sequence for individual agents; and
Operation 110 comprises determining the set of training curricula based on the first and second sets of MDPs. Purely by way of example, in this exemplary embodiment, operation 110 comprises: combining MDPs of the first and second set into vectors; generating a graph of MDPs based on the vectors; and linking MDPs based on the generated graph. In an alternative embodiment, however, the operation 110 of determining the set of training curricula based on the first and second sets of Markov Decision Processes may comprise: factoring one or more of the MDPs of the first and second set into adjusted and rearranged sequence of MDPs for a first control agent of the plurality of reinforcement learning control agents; and generating, based on the adjusted and rearranged sequence of MDPs, a training curriculum for the first control agent.

Finally, in operation 112, the macro agent communicates the set of training curricula to the plurality of reinforcement learning control agents.

Although the above-described embodiment has been detailed as employing a central, macro (i.e., teacher) agent for generating the set of training curricula, it is to be appreciated that alternative embodiments may not employ such an arrangement. For instance, in an alternative embodiment, the operation of generating a set of training curricula is undertaken by at least one of the plurality of reinforcement learning control agents.

From the above-described method, it will be appreciated that there is proposed a concept of a linked curriculum for multiple agents. This may, for example, provide faster updates and fewer disturbances to the system/environment (e.g., due to a smaller number of operations to update).

The proposed concept(s) of live environmental abstraction, reward shaping, and MDPs applied to RL techniques may be particularly advantageous for real-world systems/applications where the process is not well pre-defined and can change with time. Furthermore, there is proposed an approach of using real and predicted policies of other control agents operating in the same environment, rather than limiting training and setting to an individual, isolated control agent. Such an approach better reflects changes across the operating system/environment and helps the control agents to update based on a more realistic environment.

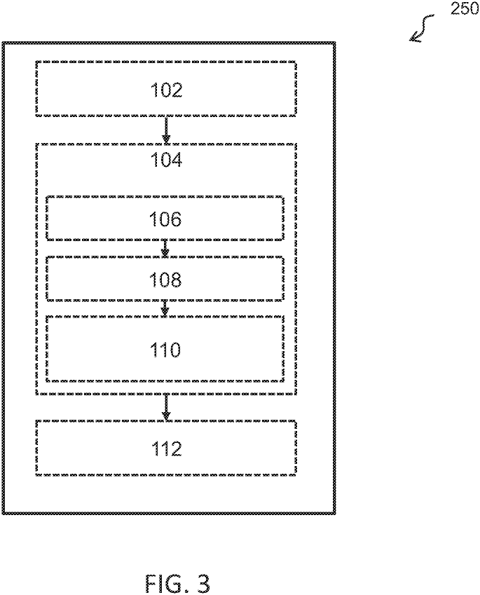

By way of further example of the proposed concept(s), it is noted that the method presented above with reference to FIG. 2 may be leveraged for reinforcement learning control of a system. For instance, referring to FIG. 3 a computer-implemented method for reinforcement learning control of a system may comprise the method 100 of training a plurality of reinforcement learning control agents according to the flow diagram of FIG. 2.

FIG. 3 illustrates a flow diagram 250 of a computer-implemented method for reinforcement learning control of a system. The method 250 comprises the operation 100 of training a plurality of reinforcement learning control agents according to the method depicted in FIG. 2.

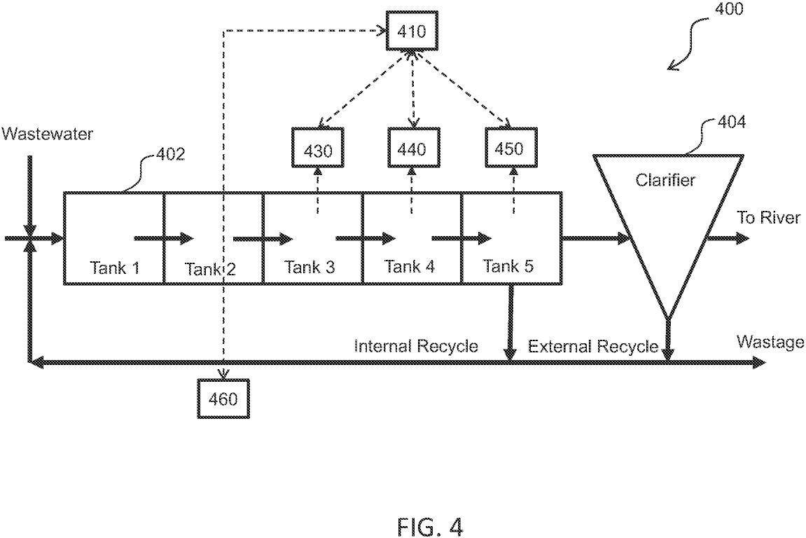

By way of further description of the proposed concepts, an embodiment will now be described with reference to the use of a set control agents for controlling various components of a wastewater treatment system depicted in FIG. 4.

FIG. 4 is a simplified block diagram illustrating the use of a set control agents for controlling various components of a wastewater treatment system 400.

The wastewater treatment system 400 comprises a biological reactor 402 including five tanks (Tank 1 through to Tank 5). The wastewater treatment system 400 also comprises a clarifier 404 which is provided with water from the fifth tank of the biological reactor 402. The clarifier 404 outputs treated water to a river and ejects wastage (for output or recycling).

The control system for the wastewater treatment system 400 comprises a macro agent 410 and a plurality of RL-based control agents 430, 440, 450, & 460.

The macro agent 410 is a teacher agent that is in charge of the training design and the overall performance and cost of the plurality of RL-based control agents (i.e., the ‘students’). The plurality of RL-based control agents 430, 440, 450 & 460 are ‘students’ that control parameters of the wastewater treatment system 400, such as aeration rates in each aerated tanks and the internal recycling rate for example. Specifically, a first RL-based control agent 430 monitors and controls an aeration rate of the third tank, Tank 3. A second RL-based control agent 440 monitors and controls an aeration rate of the fourth tank, Tank 4. A third RL-based control agent 450 monitors and controls an aeration rate of the fifth tank, Tank 5. A fourth RL-based control agent 460 monitors and controls an internal recycling rate.

The plurality of RL-based control agents 430-460 communicate information about their performance and training program to the macro agent 410 via a communication network (e.g., wireless mesh network and/or the Internet). Further, the macro agent 410 is adapted to send curriculua to the plurality of RL-based control agents 430-460 via the communication network.

The proposed implementation addresses the problem of isolated curriculum training for a complex, interdependent system such as in the wastewater treatment system 400. Also, the implementation addresses the challenge of combining multiple individual curricula into one via the following components:

(a) A component to combine the individual MDPs of control agents into vectors and graph of MDPs with attention and link to MDPs that are closely coupled. For example, in the example wastewater treatment system 400 of FIG. 4, the MDPs of the second RL-based control agent 440 (associated with the fourth tank, Tank 4) will be closely related to those of the first RL-based control agent 430 and the third RL-based control agent 450, due to the sequential nature of the process.

(b) A mixture network (that could be incorporated in whole or a part some form of neural networks) to take the set of MDPs and factorize the MDPs into adjusted and rearranged sequences of MDPs for individual agents. For example, based on the predicted policy of the first RL-based control agent 430, the new MDP for the second RL-based control agent 440 can incorporate both the new conditions of the environment (e.g., higher, more fluctuated rates of loads) and a higher treatment policy for first RL-based control agent 430.

(c) A mixture network to transform the individual rewards and indicators to a relevant metric of overall signals for the teacher.

By way of example, an embodiment for the system 400 of FIG. 4 may comprise the following operations:
Operation 1: Data streamed from the real system (from the control agents) is used to construct an MDP/RL environment. Known (or yet to be known) methods are used to create a reinforcement learning environment (the simulation) from a set of training data;
Operation 2: The macro agent 410 uses the source MDP to create sub-goals and subtasks for agent training;
Operation 3: The mixture component further processes these MDPs based on the agent linkages to change the MDP setup, such as (state, action) -> rewards;
Operation 4: Based on these remix configurations, a sequence of MDPs are sent to each RL-based control agent (i.e., each student agent) to provide a curriculum to update. The macro agent 410 (i.e., the “teacher” agent) then creates a set of sub tasks based on the environment by deciding a set of states for each of the many student agents to explore (and potentially a set of actions). Each RL-based control agent 430-460 then takes an action (self-decided) and is rewarded accordingly, where the reward is given in the simulation;
Operation 5: The RL-based control agents 430-460 send the rewards and progress signal to the macro agent 410;
Operation 6: The macro agent 410 uses a mixture network to reconfigure the signals to further process the overall reward signal and monitor control agent performance. There is a collective reward signal given back to the macro agent 410 to decide whether to update the sub tasks for the individual RL-based control agents 430-460. If the performance satisfies the training threshold, ceases curriculum updates until next request.

Although embodiments are described above in relation to a wastewater treatment system, the proposed concept(s) can be employed in a wide range of applications employing control agents utilizing reinforcement learning. Purely by way of example, such applications may include autonomous vehicle systems, artificial intelligence systems, smart home systems, etc.

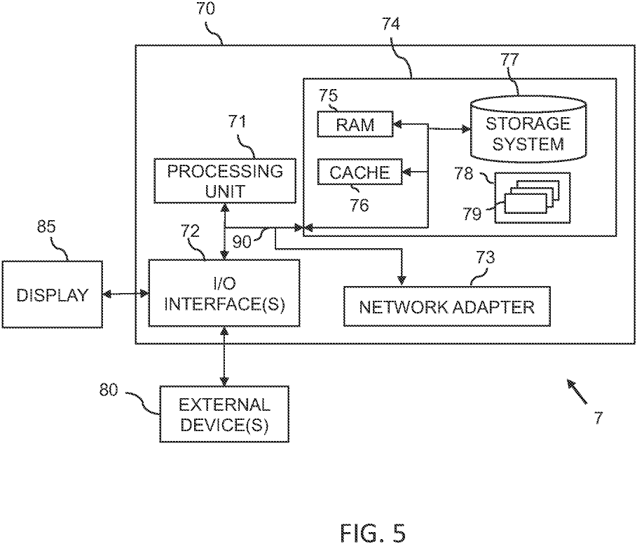

By way of further example, as illustrated in FIG. 5, embodiments may comprise a computer system 70, which may form part of a networked system 7. For instance, a system for training a plurality of reinforcement learning control agents configured to control a system may be implemented by the computer system 70. The components of computer system/server 70 may include, but are not limited to, one or more processing arrangements, for example comprising processors or processing units 71, a system memory 74, and a bus 90 that couples various system components including system memory 74 to processing unit 71.

System memory 74 can include computer system readable media in the form of volatile memory, such as random access memory (RAM) 75 and/or cache memory 76. Computer system/server 70 may further include other removable/non-removable, volatile/non-volatile computer system storage media. By way of example only, storage system 77 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 90 by one or more data media interfaces. The memory 74 may include at least one program product having a set (e.g., at least one) of program modules that are configured to carry out the functions of proposed embodiments. For instance, the memory 74 may include a computer program product having program executable by the processing unit 71 to cause the system to perform a method for training a plurality of reinforcement learning control agents configured to control a system according to a proposed concept.

Program/utility 78, having a set (at least one) of program modules 79, may be stored in memory 74. Program modules 79 generally carry out the functions and/or methodologies of proposed embodiments for training a plurality of reinforcement learning control agents configured to control a system.

Computer system/server 70 may also communicate with one or more external devices 80 such as a keyboard, a pointing device, a display 85, etc.; one or more devices that enable a user to interact with computer system/server 70; and/or any devices (e.g., network card, modem, etc.) that enable computer system/server 70 to communicate with one or more other computing devices. Such communication can occur via Input/Output (I/O) interfaces 72. Still yet, computer system/server 70 can communicate with one or more networks such as a local area network (LAN), a general wide area network (WAN), and/or a public network (e.g., the Internet) via network adapter 73 (e.g., to communicate recreated content to a system or user).

In the context of the present application, where embodiments of the present invention constitute a method, it should be understood that such a method is a process for execution by a computer, i.e., is a computer-implementable method. The various operations of the method therefore reflect various parts of a computer program, e.g., various parts of one or more algorithms.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a storage class memory (SCM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The mere fact that certain measures are recited in mutually different dependent claims does not indicate that a combination of these measures cannot be used to advantage.

Any reference signs in the claims should not be construed as limiting the scope.

What is claimed is:

1. A computer system comprising:
an interface component configured to obtain system data describing at least one operating parameter of the computer system based, at least in part, on at least one of a plurality of reinforcement learning control agents failing to satisfy a control criterion for the computer system;
one or more computer processors configured to generate a set of training curricula based, at least in part, on at least one operating parameter of the computer system and at least one training policy for the plurality of reinforcement learning control agents; and
a communication component configured to communicate the set of training curricula to the plurality of reinforcement learning control agents.

2. The computer system of claim 1, wherein the one or more computer processors are further configured to generate the set of training curricula by:
translating system data into a first set of Markov Decision Processes (MDPs);
translating the at least one training policy into a second set of MDPs; and
determining the set of training curricula based, at least in part, on the first set of MDPs and the second set of MDPs.

3. The computer system of claim 2, wherein the one or more computer processors are further configured to determine the set of training curricula based, at least in part, on the first set of MDPs and the second set of MDPs by:
combining MDPs of the first set of MDPs and MDPs of the second set of MDPs into vectors;
generating a graph of MDPs based, at least in part, on the vectors; and
linking MDPs based, at least in part, on the generated graph.

4. The computer system of claim 2, wherein the one or more computer processors are further configured to determine the set of training curricula based, at least in part, on the first set of MDPs and the second set of MDPs by:
for a first control agent of the plurality of reinforcement learning control agents, factoring one or more MDPs of the first set of MDPs and the second set of MDPs into an adjusted and rearranged sequence of MDPs; and
generating, based, at least in part, on the adjusted and rearranged sequence of MDPs, a training curriculum for the first control agent.

5. The computer system of claim 1, wherein the control criterion is selected from the group consisting of:
a reward signal representing agent performance;
a predicted performance;
a safety requirement; and
an uncertainty threshold.

6. The computer system of claim 1, wherein the one or more computer processors are further configured to train the plurality of reinforcement learning control agents according to the training curricula.

7. A computer-implemented method comprising:
obtaining system data describing at least one operating parameter of a system based, at least in part, on at least one of a plurality of reinforcement learning control agents failing to satisfy a control criterion for the system;
generating a set of training curricula based, at least in part, on at least one operating parameter of the system and at least one training policy for the plurality of reinforcement learning control agents; and
communicating the set of training curricula to the plurality of reinforcement learning control agents.

8. The computer-implemented method of claim 7, wherein generating the set of training curricula comprises:
translating system data into a first set of Markov Decision Processes (MDPs);
translating the at least one training policy into a second set of MDPs; and
determining the set of training curricula based, at least in part, on the first set of MDPs and the second set of MDPs.

9. The computer-implemented method of claim 8, wherein determining the set of training curricula based, at least in part, on the first set of MDPs and the second set of MDPs comprises:
combining MDPs of the first set of MDPs and MDPs of the second set of MDPs into vectors;
generating a graph of MDPs based, at least in part, on the vectors; and
linking MDPs based, at least in part, on the generated graph.

10. The computer-implemented method of claim 8, wherein determining the set of training curricula based, at least in part, on the first set of MDPs and the second set of MDPs comprises:
for a first control agent of the plurality of reinforcement learning control agents, factoring one or more MDPs of the first set of MDPs and the second set of MDPs into an adjusted and rearranged sequence of MDPs; and
generating, based, at least in part, on the adjusted and rearranged sequence of MDPs, a training curriculum for the first control agent.

11. The computer-implemented method of claim 7, wherein the control criterion is selected from the group consisting of:
a reward signal representing agent performance;
a predicted performance;
a safety requirement; and
an uncertainty threshold.

12. The computer-implemented method of claim 7, wherein the generating of the set of training curricula utilizes at least one of the plurality of reinforcement learning control agents.

13. The computer-implemented method of claim 7, wherein the generating of the set of training curricula utilizes a teacher agent adapted to receive system data from the plurality of reinforcement learning control agents.

14. The computer-implemented method of claim 7, further comprising training the plurality of reinforcement learning control agents according to the training curricula.

15. A computer program product comprising one or more computer readable storage media and program instructions collectively stored on the one or more computer readable storage media, the program instructions executable by one or more computer processors to cause the one or more computer processors to perform a method comprising:
obtaining system data describing at least one operating parameter of a system based, at least in part, on at least one of a plurality of reinforcement learning control agents failing to satisfy a control criterion for the system;
generating a set of training curricula based, at least in part, on at least one operating parameter of the system and at least one training policy for the plurality of reinforcement learning control agents; and
communicating the set of training curricula to the plurality of reinforcement learning control agents.

16. The computer program product of claim 15, wherein generating the set of training curricula comprises:
translating system data into a first set of Markov Decision Processes (MDPs);
translating the at least one training policy into a second set of MDPs; and
determining the set of training curricula based, at least in part, on the first set of MDPs and the second set of MDPs.

17. The computer program product of claim 16, wherein determining the set of training curricula based, at least in part, on the first set of MDPs and the second set of MDPs comprises:
combining MDPs of the first set of MDPs and MDPs of the second set of MDPs into vectors;
generating a graph of MDPs based, at least in part, on the vectors; and
linking MDPs based, at least in part, on the generated graph.

18. The computer program product of claim 16, wherein determining the set of training curricula based, at least in part, on the first set of MDPs and the second set of MDPs comprises:
for a first control agent of the plurality of reinforcement learning control agents, factoring one or more MDPs of the first set of MDPs and the second set of MDPs into an adjusted and rearranged sequence of MDPs; and
generating, based, at least in part, on the adjusted and rearranged sequence of MDPs, a training curriculum for the first control agent.

19. The computer program product of claim 15, wherein the control criterion is selected from the group consisting of:
a reward signal representing agent performance;
a predicted performance;
a safety requirement; and
an uncertainty threshold.

20. The computer program product of claim 15, wherein the method further comprises training the plurality of reinforcement learning control agents according to the training curricula.
